(19) United States
(12) Patent Application Publication
(10) Pub. No.: US 2025/0242225 A1
(43) Pub. Date: Jul. 31, 2025

(54) GOLF PUTTING AID

(71) Applicant: Russell J. KALIL, Ridgefield, CT (US)

(72) Inventor: Russell J. KALIL, Ridgefield, CT (US)

(21) Appl. No.: 19/020,390

(22) Filed: Jan. 14, 2025

Related U.S. Application Data
(60) Provisional application No. 63/626,089, filed on Jan. 29, 2024.
(60) Provisional application No. 63/551,725, filed on Feb. 9, 2024.
(60) Provisional application No. 63/551,746, filed on Feb. 9, 2024.
(60) Provisional application No. 63/654,961, filed on Jun. 1, 2024.
(60) Provisional application No. 63/663,173, filed on Jun. 23, 2024.
(60) Provisional application No. 63/697,630, filed on Sep. 23, 2024.

(51) Int. Cl. A63B 69/36; A63B 24/00

(52) U.S. Cl. CPC A63B 69/3685; A63B 24/0006; A63B 24/0021; A63B 2024/0056; A63B 2220/805; A63B 2220/833

(57) ABSTRACT

A putting aid device (704) and associated functionality are provided for on-course and routine practice session use. The device (704) can be attached to the putter via a mount (706). The mount (706) is positioned near the top end of the putter. The device (704) uses an optical system, such as LiDAR or a camera of the device (704), to monitor movement of the face (712) and a golf ball. A user (700) holds the putter in a position to address the golf ball (703) on a putting surface (701). The device (704) may provide information to users concerning properly addressing the ball, assisting in aiming the ball towards a target and judging the proper putting force, recording results of putts, providing analytics in relation to attempted putts, and other information to assist a user in attempting a putt, analyzing putting performance, and improving putting skills.

### RELATED APPLICATION INFORMATION

The present application is a non-provisional of the following U.S. Provisional Patent Applications (“the Parent Applications”):
1. Ser. No. 63/626,089 entitled, “Game Show-Use Technology to Level Playing Field for Amateurs versus Professionals,” filed on Jan. 29, 2024.
2. Ser. No. 63/551,725 entitled, “Determination of a Golf Ball Pathway Using a Virtual Golf Ball on a Virtual Mesh,” filed on Feb. 9, 2024.
3. Ser. No. 63/551,746 entitled, “Enhanced Golf Putt Accuracy Using Combination of Hardware Placement and Geometry Methods,” filed on Feb. 9, 2024.
4. Ser. No. 63/654,961 entitled, “Measurement of Golf Putt Metrics Using Novel Combination of Hardware Placement and Geometry Methods,” filed on Jun. 1, 2024.
5. Ser. No. 63/663,173 entitled, “Measurement of Golf Putt Metrics Using Novel Combination of Hardware Placement and Geometry Methods,” filed on Jun. 23, 2024.
6. Ser. No. 63/697,630 entitled, “Measurement of Golf Putt Metrics Using Novel Combination of Hardware Placement, Geometry Methods and Stroke Mechanics,” filed on Sep. 23, 2024.

The contents of the Parent Applications are incorporated herein by reference as if set forth in full and priority is claimed to the full extent allowable under U.S. law and regulations.

### FIELD OF THE INVENTION

The present invention relates to golf aids and, in particular, to a putting aid system and associated functionality for use by a golfer for training and to execute putts and other strokes.

### BACKGROUND OF THE INVENTION

In recent years, various technology systems have been developed for golfers. One example is launch monitors that track a golfer's swing and the ball's flight. These technologies can be used for various applications including equipment fitting, enabling analysis of swing mechanics, simulated course play, and others. While these systems are useful, their application is limited. They are generally complex and expensive systems. Therefore, the golfer usually accesses such equipment at a specialized facility. Such equipment typically is not available for use on the golf course or in routine practice, e.g., at home, on a conventional driving range, on a practice green, or the like.

In many cases, these technologies are not designed to assist golfers with analyzing and training for putting. Experienced golfers understand that putting is critical to good scoring. Indeed, some estimates indicate that, on average, nearly half of the strokes in a golf game are putts. Therefore, golfers desiring to improve scoring devote considerable effort to improving putting. Traditionally, this involves hours of practice as well as lessons from a golf instructor or professional. The goal is to identify and correct any undesirable putting patterns, improve form, achieve consistency, and gain experience.

Certain golf aides have been developed to assist putters in improving putting, both during games and in routine practice. For some courses, green topography maps are available. These maps show the slope of areas of greens to assist golfers in judging the break of a putt. Information may also be available concerning the current green speed such as stimp rating information. Leveling gauges may also be used to measure the slope of an area of a green. In addition, devices similar to launch monitors (with an optional putting add-on) may be used to monitor a putting stroke and swing dynamics. However, such monitoring devices generally are not available to assist golfers during golf rounds or in routine practice sessions.

Other technologies have been developed for purposes other than putting aids. For example, various fitting tools have been developed for club fitting, i.e., selecting a putter, sizing a putter for a golfer, or determining an optimal putter based on a putting style or characteristics. In some cases, these fitting tools have involved attaching a sensor device to the putter to monitor practice putts. However, such fitting tools generally are not adapted for use as a putting aid. For example, they may not provide the types of information necessary to assist a golfer in putting training or they may not be available for use in course play or routine practice sessions.

### SUMMARY OF THE INVENTION

The present invention is directed to a golf putting aid and associated functionality to assist golfers during on-course play or in routine practice sessions. In certain embodiments, the putting aid can be attached to a putter, and can operate without a continuous network connection, for convenient use in various practice and play environments. The putting aid does not require large or specialized equipment and can be embodied in a mobile device together with a putter mount. In this manner, the putting aid can be used frequently and over long time periods to develop good habits and improved putting form, and to improve consistency to enable better golf scoring.

In accordance with one aspect of the present invention, a putting aid system for golfers is provided. The system includes a user device for monitoring a putting environment and a mount for mounting the user device on a putter. The user device includes a monitoring unit and a processor for receiving monitoring information from the monitoring unit and providing putting aid information based on the monitoring information, where the putting aid information aids a user in executing a putt or provides result information based on monitored putts. For example, the user device may be embodied in a mobile device such as a phone that is mounted on a putter shaft. A display of the mobile unit may display a projected putting path prior to executing a putt and display information regarding the result of a putt or a series of putts.

In one implementation, the monitoring unit may include one or more optical units such as a LiDAR unit and/or a camera. The optical unit can be used to scan the putting surface and generate a virtual mesh, including any contours, for use in determining the positions of objects, monitoring movement, and calculating various putting parameters. The system may further be operative for generating virtual objects such as a virtual putter face, a virtual golf ball, and a virtual putting target such as a cup. These virtual objects can be used to execute virtual putts, or the virtual objects can be overlaid on corresponding real-world objects to provide putting aid information during on-course play or routine practice sessions. The system can use the virtual objects to determine a variety of putting parameters such as putt length, putter face direction, cup direction, putt stroke force, swing dynamics parameters, and the like. These parameters can be used to determine putting aid information for display to the user to guide the user in executing a putt or provide feedback concerning putting performance.

The user device can be mounted on the putter shaft in a manner that minimizes the impact of the device on the putting force exerted on the golf ball and the putting feel. The user device can be a relatively lightweight device such as a mobile phone. In addition, the device can be mounted near the top end of the putter shaft (e.g. at the top end of the grip above the hands) where the weight of the device has a minimal impact on the device's contribution to the moment of inertia of the putter. Moreover, in this position, the display of the mobile device is available to provide real-time feedback to the user regarding putts.

While such a mobile phone implementation has been found to provide excellent monitoring and is readily available to users without requiring substantial additional equipment, it will be appreciated that certain aspects of the invention can be implemented in other ways. For example, the optical unit and/or other components can be separated from the user device implementing the display, e.g., the optical unit may include a compact, wireless Wi-Fi camera paired with a mobile unit. Such a compact optical unit may allow for a greater range of optical unit placement relative to the putter, for example, on the shaft farther away from top of the putter and center of rotation and allow certain components to be separated from the putter during use.

In accordance with another aspect of the present invention, a putting aid system provides putting aid information without using sensors that sense movement of the user device. The system includes a monitoring unit for monitoring objects and/or movement within a field of view of the monitoring unit and a processor for processing the monitoring information. The system further includes a mount for mounting the monitoring unit on a putter. The processor is operative for monitoring, based on the monitoring information, one or more parameters concerning putting a golf ball using a putter.

For example, the monitoring unit may comprise an optical unit such as a LiDAR unit and/or a camera. As discussed above, it is useful to locate the user device at or close to the top end of the putter where the device is near a center of rotation of the golf swing and, therefore, the device movement is minimized. However, when device movement is minimized, the effectiveness of on-board sensors for sensing device movement is reduced. In accordance with the present invention, the device can be used to monitor the putting environment using optical equipment rather than such on-board device sensors. For example, this can be accomplished by creating a virtual, stationary mesh extending across the putting surface and monitoring the position and movement of virtual objects such as a virtual putting face, a virtual ball, and a virtual cup in relation to the virtual mesh. Accurate putting parameter information can thereby be obtained without relying on device sensors.

In accordance with a still further aspect of the present invention, a golf putting aid system provides golf aid information using an augmented reality technology. The augmented reality technology involves a display that displays putting environment images with putting aid information superimposed on the real-world putting environment. The associated system includes a user device for monitoring a putting environment, where the user device includes an optical unit for providing imaging information regarding the putting environment, a processor, and a display for displaying imaging information. The processor is operative for combining augmented reality content with the imaging information. For example, the augmented reality content may include a projected pathway of a putt, displayed prior to attempting the putt or after a putt is attempted, or information concerning a putting stroke, putting surface contours, or other information. Preferably, the system can be implemented on a mobile unit without the need to establish a network connection to an external network platform. In this manner, the system can be used in a variety of putting environments including on-course play and routine practice sessions even if a network connection is not available.

### BRIEF DESCRIPTION OF THE DRAWINGS

For a more complete understanding of the present invention, and further advantages thereof, reference is now made to the following Detailed Description, taken in conjunction with the drawings, in which:

FIG. 1 illustrates a golfer on a putting surface such as a contoured putting green;

FIG. 2 shows a putting aid device in accordance with the present invention mounted on a putter;

FIG. 3 illustrates a putter face alignment process in accordance with the present invention;

FIG. 4 illustrates a virtual mesh, virtual putter, and virtual ball generated by a putting device in accordance with the present invention;

FIG. 5 illustrates a virtual golf ball rolling on a virtual mesh in accordance with the present invention;

FIGS. 6A-6B show a putting aid in accordance with the present invention mounted on a putter;

FIG. 7 is a front view of a golfer holding a putter with a mounted putting aid device in accordance with the present invention;

FIGS. 8-10 show screenshots related to a putter face centering process generated by putting aid device in accordance with the present invention;

FIG. 11 shows a screenshot related to a putting angle generated by a putting aid device in accordance with the present invention;

FIG. 12 shows a series of screenshots and a user interface related to setting up and executing a putt in accordance with the present invention;

FIG. 13 illustrates an aim offset metric in accordance with the present invention;

FIG. 14 illustrates a user interface related to a virtual putt in accordance with present invention;

FIG. 15 illustrates parameters for analyzing putting stroke dynamics in accordance with the present invention;

FIG. 16 shows a user interface for entering putt parameter information in accordance with the present invention;

FIGS. 17-18 show user interfaces providing analysis of putts in accordance with the present invention;

FIG. 19 illustrates an example of real-world putt feedback in accordance with the present invention;

FIG. 20 is a block diagram illustrating a putting aid system in accordance with the present invention;

FIG. 21 is a flow chart illustrating a putting aid process in accordance with the present invention; and

FIG. 22 illustrates a virtual ARC stroke tool in accordance with the present invention.

### DETAILED DESCRIPTION

The present invention relates to a putting aid system and associated functionality for on-course and routine practice session use. In the following description, the invention is set forth in the context of an implementation embodied as an application running on a mobile device, such as a phone, mounted on a putter. The application can function without an Internet connection. While this is an advantageous implementation, various aspects of the present invention are not limited to this implementation or context. Accordingly, the following description should be understood as exemplary and not by way of limitation.

The putting aid system of the present invention can be used in various environments including in the user's home, in the user's office, on a practice green, or on the golf course during a round. In any such environment, a user can practice by putting a golf ball, or a virtual golf ball, on a virtual surface or real surface such as a carpet, artificial turf, a putting green, or other putting surface. The system can be used in connection with putting a real ball towards a real target such as a golf hole/cup or putting a virtual ball towards a virtual target. In either case, the system may provide information to users concerning properly addressing the ball, assisting in aiming the ball towards the target, assistance in judging the proper putting force for a putt, recording the results of putts, providing analytics in relation to attempted virtual and real world putts, and other information to assist a user in attempting a putt, analyzing putting performance, and improving putting skills.

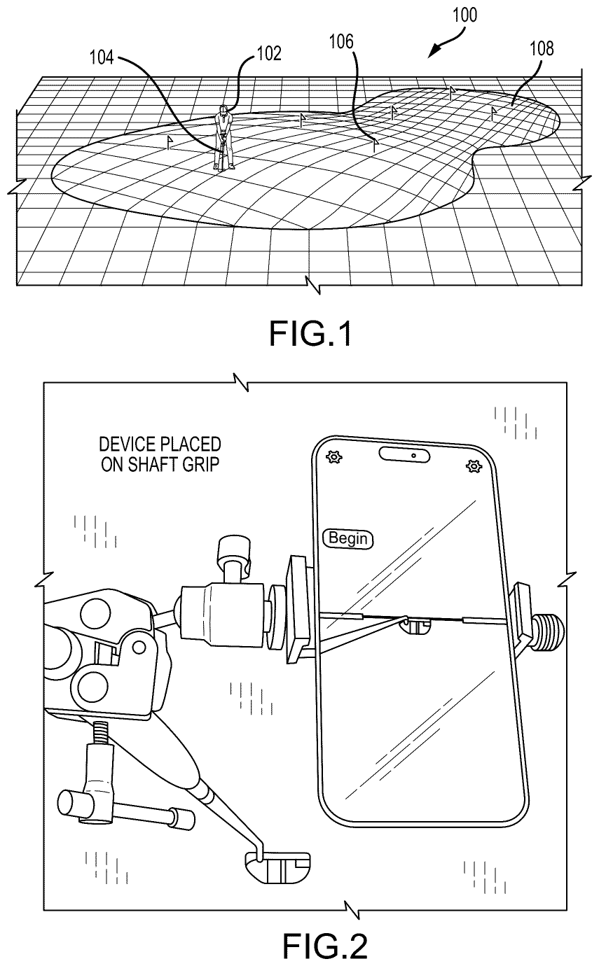

FIG. 1 shows one use environment, specifically, use of the device on a practice green 100. In this case, a user 102 with a putter 104 practices putts directed to a real golf hole marked by a pin 106. The illustrated putting green is contoured as indicated by contour lines 108. Accordingly, some of the subsidiary skills to be practiced include centering the ball on the putter face, executing a consistent putting stroke, judging the required distance of the putt, and judging the break of the putt, among others. It will be appreciated that mastering these skills requires many hours of practice, typically over a period of years. Even when these skills have been mastered, continued practice is required to maintain these skills.

The present inventor has recognized that the process of mastering these skills can be enhanced by use of a putting aid that provides real-time feedback concerning a putt being lined-up as well as feedback concerning a putt attempted or aggregated analysis of multiple putts. However, in order to provide real-time feedback in a variety of settings including on-course play and routine practice sessions, it is useful to provide a system with user interfaces that can be viewed during the putting process, e.g., when lining-up a putt, in connection with practice swings, and reviewing the results of a putt. One way of providing these user interfaces while putting involves mounting a putting aid system on the putter. This allows the user to obtain information in advance of an attempted putt, such as a preview of a putt face direction in relation to the cup, and immediately upon attempting a putt, such as reviewing an actual putt outcome in relation to a desired or optimal pathway (i.e. land in the cup). In this manner, the user can make corrections before attempting a real-world putt or on a subsequent virtual putt. In addition, for the system to operate in a variety of environments including on-course play, potentially in remote locations, it is useful to provide a system that can function without requiring a continuous network connection, e.g., a wireless connection to the Internet.

The putting aid system can be used to execute a virtual putt or a real-world putt. For a virtual putt, the user uses a virtual, invisible putter head whose putter face is always directly superimposed over the putter face of the real putter face. This alignment of putter head faces is accomplished during the initial setup when the device is mounted onto the putter. The user then lines up a putt by viewing the display of the user device, where the display shows the real putter head and an augmented reality representation of a virtual ball and, perhaps, a virtual cup or other target. The user can then swing the putter to “strike” the virtual ball using the virtual putter face superimposed upon the real putter face and see the resulting virtual putt on the display. As described below, the virtual ball rolls on a virtual surface, defined by a mesh, that may include contours. To enhance the effect of the virtual putt, haptics, sound, and other effects may be provided. This allows the user to practice putting skills in almost any environment without the need to place or retrieve golf balls.

For a real-world putt, the putting aid system can be used to scan for the real ball and cup. It can then use AI/ML or other logic to recognize the ball and cup and their real world locations, and generate a virtual ball and virtual cup and place them on the established virtual mesh at their corresponding real world locations. Then, as with the virtual putt, the system can, using the real world virtual object equivalents, provide line up and guidance information in advance of a putt, monitor the putt in real time by updating their AI/ML real world locations, and provide outcome information for a putt or series of putts as well as other information such as an analysis of swing mechanics.

There are a few challenges related to mounting a golf putting aid on a putter. A first set of challenges relates to weight. It is desirable that the putting aid system not unduly affect the force imparted on the ball or the putting feel. Modern putters have been designed so that they are lightweight. For example, the difference between a putter classified as light versus a putter classified as heavy may only be about 2 oz. or 60 grams. By contrast, if the putting aid system is to be embodied in a mobile device such as a phone, a typical phone may weigh about 8 oz. and an appropriate clamp may weigh an additional 6 oz. Accordingly, the putting a device could add about 14 oz. or 400 grams to the cumulative weight of the putter.

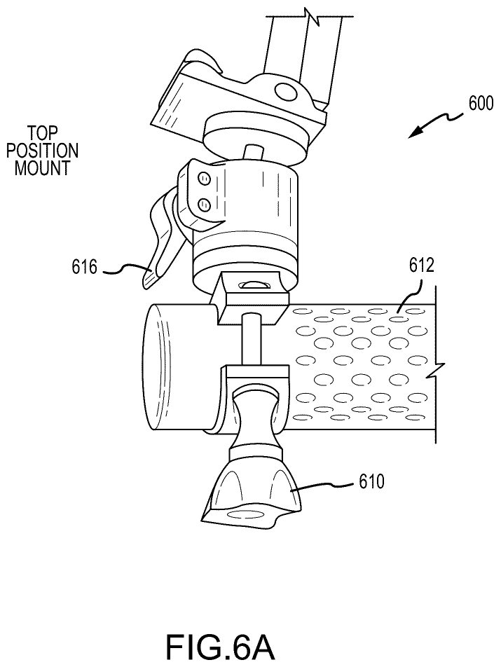

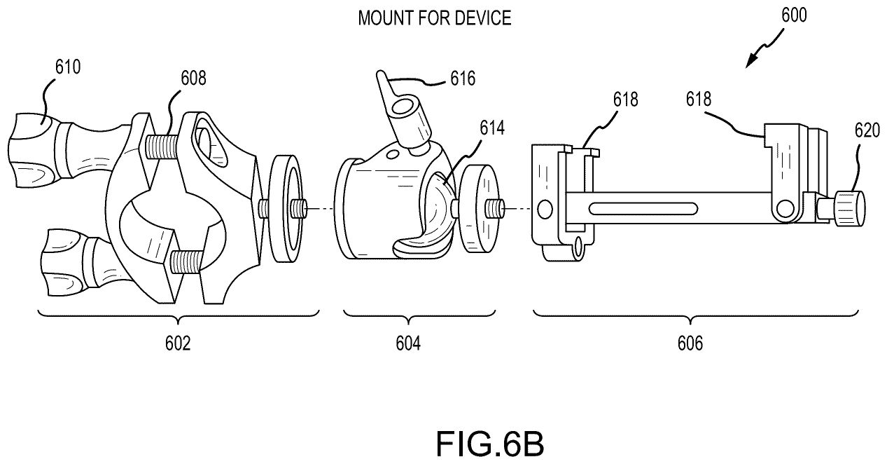

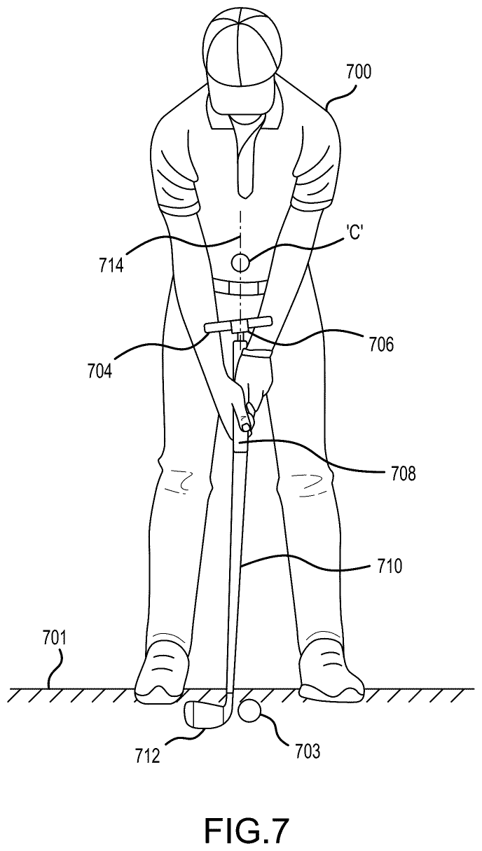

However, the impact of the putting aid device on putting strike force and putting feel is not only a function of the putting aid device weight (and relative weights of the device and putter) but, more specifically, the overall moment of inertia of the putting aid device in use (and relative moments of the device and putter). This can be understood by reference to FIG. 7. FIG. 7 shows a user 700 holding a putter in a position to address a golf ball 703 on a putting surface 701. As shown, the putter includes a grip 708, a shaft 710, and a face 712. A significant portion of the weight of the putter is in the face 712. As shown, the device 704 can be attached to the putter via a mount 706. The illustrated mount 706 is positioned near the top end of the putter opposite the bottom end of the putter and the face 712. FIGS. 2 and 6A show the device mounted on the putter shaft.

Golfers are instructed to execute a putting stroke as a pendulum-like movement where much of the motion is due to movement of the user's shoulders and arms with some wrist movement. The cumulative effect is that the putting stroke closely resembles the movement of a pendulum centered at a center point C, typically close to the user's naval, where an axis 714 of the putter essentially pivots about the center point. This varies some depending on individual putting strokes as well as the type of putter utilized, e.g., a conventional putter, a long putter, or a belly putter. In any event, the putting stroke resembles pendulum-like movement with the least movement experienced near the center of rotation. Accordingly, by positioning the device 704 near the top end of the putter, the impact of the device on putting force and putting feel can be minimized.

As shown if FIG. 7, the illustrated device 704 is preferably mounted on the putter so that the device 704 is positioned near the top end of the putter. In particular, the mount 706 is preferably attached to the putter above the user's hands, for example, within about three inches and, more preferably, within about 1 inch of the top of the putter. This positioning not only reduces the contribution of the device to the overall moment of inertia of the putter and device, but also does not interfere with gripping the putter and enables convenient viewing of the screen.

As is well known, moment of inertia is a function of the mass of constituent elements of the system and is a function of the square of the distance of each such element from the center of rotation. Accordingly, by positioning the device 704 close to the center of rotation, the impact of the mass of the device 704 on the moment of inertia of the system is minimized. By contrast, the contribution to the overall moment of inertia from the putter face 712 is substantial due to the distance of the face 712 from the center of rotation. Accordingly, even if the weight of the device 704 is substantial in relation to the weight of the putter the impact of the device on strike force and putting feel is minimal.

A second set of challenges relates to sensors or instrumentation. Modern mobile devices include a variety of sensors that could be employed to monitor various putting parameters. For example, accelerometers and tilt sensors (e.g., gyro-based) could be employed to track key putt metrics like putting direction, acceleration, and face angle. However, for these sensors to provide useful and accurate information, significant movement of the mobile device is required. Of course, positioning the device 704 to provide significant movement of the mobile device mounted on the putter may have a significant impact on the strike force imparted on the ball and the putting feel. Conversely, positioning the device 704 near the top end of the putter and close to the center of rotation as illustrated could reduce the effectiveness of device sensors.

The present invention overcomes this difficulty by monitoring putt parameters and swing dynamics without relying on accelerometers, gyros, or other device sensors that are based on sensed movement of the device. Rather, the present invention employs one or more environment monitoring tools that monitor the position and/or movement (or derivatives thereof) of the putter, ball, target, and the like. In one implementation, as will be described in detail below, the device 704 uses an optical system, such as LiDAR and/or a camera of the device, to monitor movement of the face 712 and, in certain implementations, a golf ball. The optical system may also be used to monitor and record the position of a target, the contours of a putting surface, and other parameters. For example, the LiDAR system may be used to generate a virtual mesh. The mesh may optionally follow contours of a putting surface. The virtual mesh is stationary, and movement of the face 712 and a golf ball can be monitored in relation to the virtual mesh. In this regard, it will be appreciated that such movement is not monitored based on device motion sensors but, rather, based on optically detected environmental information. Such optical information may be determined, for example, in relation to visible light or other spectral radiation. Augmented reality can then be used, for example, to overlay a projected or actual putting path on a real image of the putter and putting surface displayed on the mounted mobile device.

To generate a virtual mesh, the device is first mounted on a putter. Specifically, a putting aid application in accordance with the present invention (previously downloaded and stored) is launched on the mobile device. The mobile device is then securely clamped in a cradle of the mount. The mount, in turn, is securely clamped to the putter, preferably at or near the top end of the putter. The illustrated clamp allows for adjusting the orientation of the mobile device relative to the axis of the putter as well as an axis perpendicular to the axis of the putter (see FIGS. 2 and 6A-6B). In this manner, the device can be positioned so that it is readily viewed by the user and also to align the putter as described below.

FIGS. 6A-6B show side and exploded views of one example of a mount 600 in accordance with the present invention. A variety of clamps can be used to attach the device to the putter shaft. Preferably, the clamp is lightweight, accommodates a variety of putter dimensions and shapes, has a narrow profile so that it doesn't interfere with the user's arms and grip, is adjustable relative to two axes to facilitate alignment, and can be easily and securely fixed in position to maintain alignment. The illustrated mount 600 includes a clamp 602 for attaching to the putter shaft, a joint mechanism 604, and a device cradle 606. The illustrated clamp 602 includes two bolts 608 and finger nuts 610. The finger nuts 610 can be loosened to expand the clamp 602 so that the clamp can slide over the end of the putter shaft and grip 612 into position near the end of the grip 612. Once in position, the nuts can be tightened to secure the clamp 602 in place. The clamp 602 is also effective to select the orientation of the mount 600 on the shaft.

The joint mechanism 604 allows for rotation of the cradle 606 relative to the clamp 602. The illustrated mechanism 604 includes and ball and socket joint 614 and a quick release lever 616. The joint 614 allows for rotation of the cradle about multiple axes. In particular, the user device in the cradle 606 can rotate about a top-to-bottom axis and a side-to-side axis of the user device. In this manner, a reference line on the display of the user device can be aligned with the face of the putter as displayed on the user device. The quick release lever 616 can be moved between an open position (as shown) which allows for movement of the joint and a closed position where the joint is locked in place to secure the cradle 606 and user device. In operation, the user can open the lever 616 to move the joint 614, while monitoring the screen of the user device, until the device is properly aligned, and then close the lever to fix the position of the joint. The position will then be maintained throughout a practice session or until the mount 600 is moved.

The cradle 606 includes arms 618 for engaging the sides of the user device and a finger nut 620. The nut 620 can be loosened to allow telescoping movement of the arms to engage the user device and then tightened to securely grip the user device in the cradle 606.

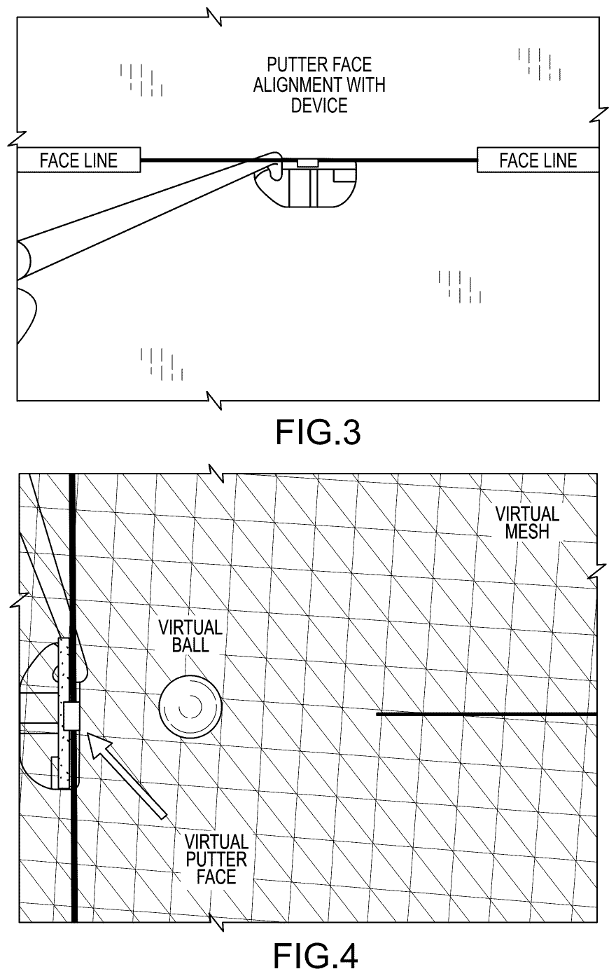

The putter face can then be aligned as shown in FIG. 3. In order for the virtual environment to be accurately projected onto the real-world environment as displayed on the mobile device display, and for the virtual mechanics to accurately match the real-world mechanics, it is important that the virtual environment is aligned with the real-world environment. To assist in such alignment, the system can overlay a reference line on the display. The adjustment mechanisms of the mount, as described above, can then be used to position the mobile device so that the face of the putter head is aligned with the reference line. The adjustment mechanisms can then be secured to lock the mobile device in this position. It will be appreciated that such alignment may be executed in different ways. For example, the system may be designed so that the user can position the display in any position that is comfortable for viewing the display. Appropriate logic, such as artificial intelligence, may then be utilized to recognize the putter face and putting surface and to establish a reference line and/or register the virtual environment in relation to the real-world environment as represented in the display.

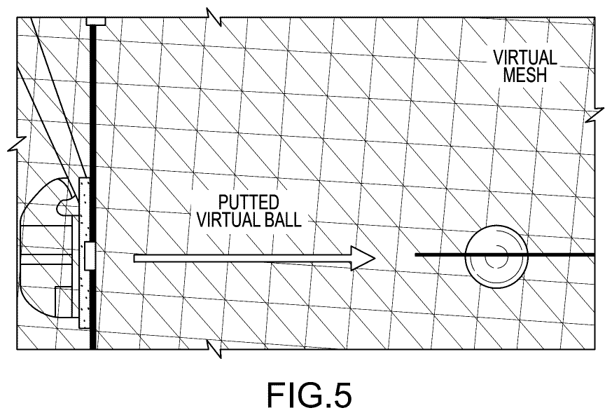

In the illustrated embodiment, as shown in FIG. 4, a LiDAR system of the mobile device is then operated to scan the putting surface and create a virtual mesh. It will be appreciated that this virtual mesh may extend beyond the field of view of the device camera. For example, the mesh may extend across a radius of 20 feet or more from the device position. In addition, the mesh may replicate the topography of the putting surface. FIG. 5 shows a virtual ball rolling on the virtual mesh.

Monitoring of a putting stroke and a putt may involve several key metrics. These key metrics may include centering of the golf ball in relation to the face, the angle of the face, the putt distance, the putt stroke force, the target direction, and other parameters. These parameters may be monitored for multiple purposes including providing feedback concerning the geometry of addressing the golf ball, the aim direction for a putt (in relation to the target direction), the strike force for a putt, the anticipated break of a putt, the stroke dynamics of a putt, and the result of a putt including whether the ball misses to the right of the cup, misses to the left of the cup, misses short of the cup, extends beyond the cup, or successfully enters the cup.

Some of the physics and math for determining key metrics, which are well-understood, are summarized below together with figures illustrating a system set-up process. In some cases, these are described in relation to using a virtual putter superimposed on the real putter to strike a virtual ball (see FIG. 5) towards a virtual target (e.g., a virtual cup). It will be appreciated that these relationships are readily extended to a real ball and real target, e.g., for use in obtaining guidance in advance of a putt, by positioning the virtual ball and virtual target to match the actual positions of a real ball and target, as will be described below.

### Putt Distance

The putt distance can be determined by identifying the starting point of a putt and the target of a putt relative to the virtual mesh and then using trigonometry to measure the three-dimensional distance between the starting point and the target.
1. Using the LiDAR scanners described above, a virtual mesh is established replicating the topography of the surrounding putting area.
2. Appropriate logic, such as artificial intelligence/machine learning (AI/ML) logic is then employed to identify the three-dimensional position of a ball and cup. For real-world putting surfaces, the logic can automatically detect the ball and cup as part of the scan process. The logic then places virtual equivalents (e.g., a large blue disk over the cup and a small blue sphere on the ball) at the appropriate locations on the mesh. In the case of a virtual ball and cup, using appropriate user interface elements, a virtual ball and a virtual cup may be located at desired positions on the virtual mesh. The AI/ML logic is operative to scale display representation of the virtual ball and cup to the appropriate size based on the real-world sizes of the ball and cup the positions of the virtual objects relative to the virtual mesh. As an alternative to automatic AI/ML generation of the virtual ball and cup, in the case of a real ball and cup, the virtual ball and cup may be manually positioned to coincide with the real-world ball and cup and the process proceeds as with the virtual ball and cup. For example, the user can tap on the screen to generate the virtual ball, or a cursor may be positioned on the real-world ball and then a soft button (of the putting aid application) may be used to generate a virtual ball at that location. A similar process can be used to generate a virtual cup at the location of the real-world cup. A real ball and a virtual ball (as well as a real cup and a virtual cup) can coexist on the screen. The application dashboard (and its metrics) only activates when a specific ball is addressed (e.g., when the putter face is close to a ball). The Metrics may be based on which ball is addressed so, for example, a virtual ball distance could be different than a real ball distance.
3. The system is then operative to determine the distance between the virtual ball and the virtual cup (which will match the real-world distance in the case of a real ball and cup) on the mesh using a common mesh origin and applying a three-dimensional version of the Pythagorean theorem, or corresponding trigonometry, to determine the distance of the putt.

### Centering the Ball and Putter Face

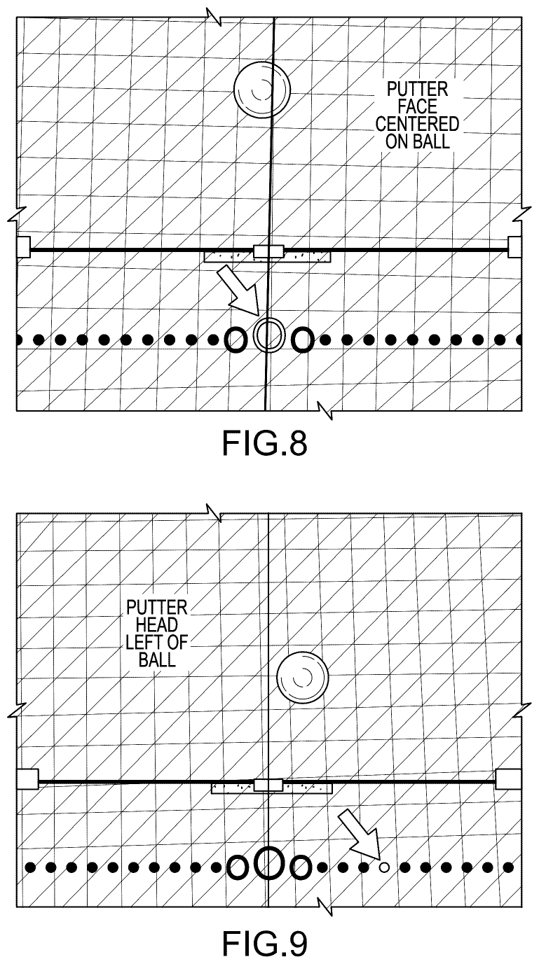

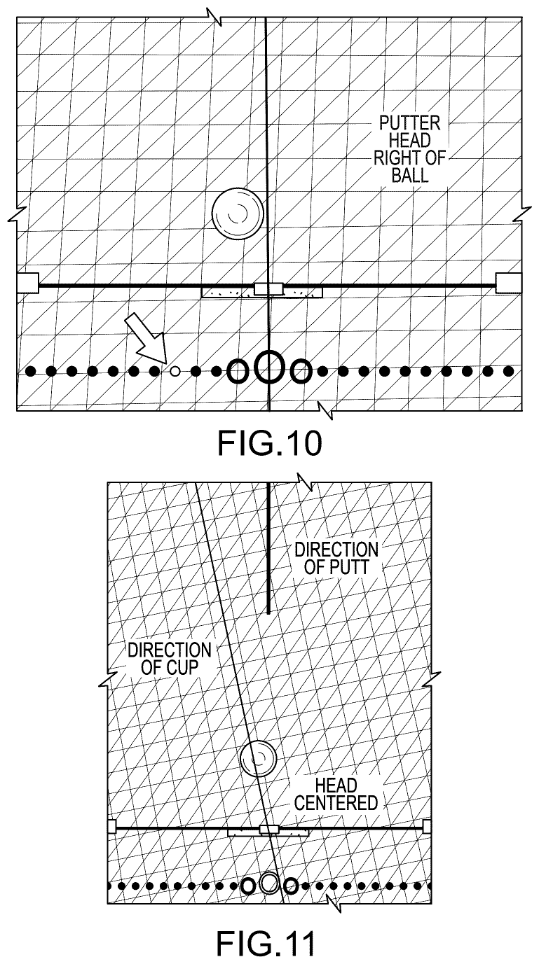

Centering the putter face relative to the ball is important both as a matter of proper putting form and also so that the putting mechanics that are calculated and displayed to the user match the real-world parameters.
1. A virtual putter face is generated by the putting aid application and placed in the physical and/or logic center of the device screen. The virtual putter face is then aligned with the real-world face, for example, using the clamp adjustments or software-based position calibration as described above. The virtual putter face is then able to interact with the virtual ball. The system may assign a size and weight to the virtual golf ball that matches a real-world golf ball. Moreover, the user may enter information concerning the real- world environment, such as the weight of the putter head, the speed of the green, and the like, so that the system can generate results that match the real-world conditions.
2. Using the center point of the virtual putter object and the center point of the virtual cup object, a bearing connecting the putter head and cup is calculated.
3. Using the center point of the virtual ball object and the center point of the virtual cup object, a bearing connecting the ball and the cup is calculated.
4. Next, a difference between the ball-to-cup bearing and the putter-to-cup bearing is determined.
5. The application will then present a visual indicator (see FIGS. 8-10) that represents this difference. If the difference is zero, the virtual ball, the virtual putter, and the virtual cup are aligned and centered. If there is a difference, this is indicated to the user in the display so that appropriate alignment correction can be implemented.

### Putt Angle

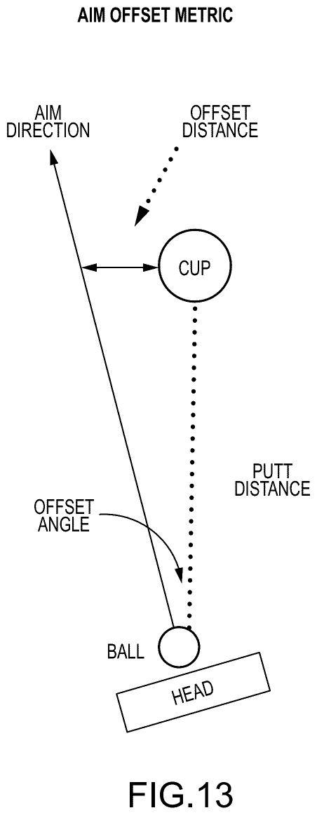

A fundamental putting skill is learning to consistently strike the ball at a desired angle so that the putt is properly directed towards the target. For more advanced implementations, this may take into account the contours of the putting surface, the speed of the green, the strike force applied to the ball, and other factors. In a simple case, however, this relates to building the skill of aligning the putter face and putting stroke so that the ball is directed towards the cup on a flat surface. In any case, the application may provide feedback to the user by showing a difference between the aim direction indicated by the orientation of the putter face and the target direction indicated by the ball-to-target bearing (or initial ball direction in the case of a putt including a calculated break).
1. Using the center point of the virtual putter object and the center point of the virtual cup object, a putter to cup bearing is calculated. In cases where the contours of the green are taken into account to determine a break of the putt, an initial ball direction may be determined and displayed. This is used for the target direction.
2. An additional triangulation object can then be created. The triangulation object is located on a line extending through the center point of the virtual putter face, where the line is perpendicular to the face of the putter face. The triangulation object may be located at a defined distance from the putter face.
3. Using the center point of the triangulation object and the center point of the virtual putter face object, a triangulation object to putter bearing is calculated. This is the direction in which the putter face is pointing. This is used for the aim direction. As shown in FIG. 11, both the target direction (direction of cup) and the aim direction (direction of putt) may be displayed so that the user receives feedback concerning the putt angle.
4. The difference between the aim direction and the target direction can be used to calculate the offset angle of the putter relative to the direction of the virtual cup.
5. The application can present a visual indicator concerning the direction of the face in relation to the desired direction of the putt (see FIGS. 11, 13, and 14). For example, if the difference between the aim direction and the target direction is 0, the associated vectors may be displayed as being aligned or another indication may be provided to indicate that the putt is properly lined-up. If the difference is not 0, the displayed vectors may be shown as unaligned or other information may be displayed indicating that the putt is misaligned to the left or misaligned to the right. Also, the offset distance can be derived from the offset angle by using the product of the tangent of the angle and the distance of the putt, i.e., the ball location (at the instant the ball is projected to pass by the cup) to cup distance-also known as the “putt break distance.”

### Putt Stroke Force

In certain contexts of the present invention, it is useful to estimate the force exerted on a golf ball by the putter face or related quantities such as the initial velocity of the golf ball. For example, in connection with projecting the putting path and distance of a virtual ball, the putting force may be estimated. Similarly, the putting force may be estimated in connection with projecting a path and distance of a real ball, for example, based on a practice swing. To determine the putting force required to move a golf ball a certain distance or determine the distance that a golf ball will travel based on a given putting force, several factors may be considered including, e.g., the mass of the golf ball, the acceleration imparted to the golf ball during impact, and the duration of the impact between the face and the ball. Additional factors such as the speed of the putting green, contours of the putting green, and the like may be considered. The mechanics for determining a putt path and distance based on these factors are well understood and may involve laws of motion such as Newton's second law, conservation of momentum, and conservation of energy. Additionally or alternatively, AI/ML logic may progressively learn to estimate a putting path and distance based on measured parameters, estimated parameters, and information provided to the system such as characteristics of the putter.

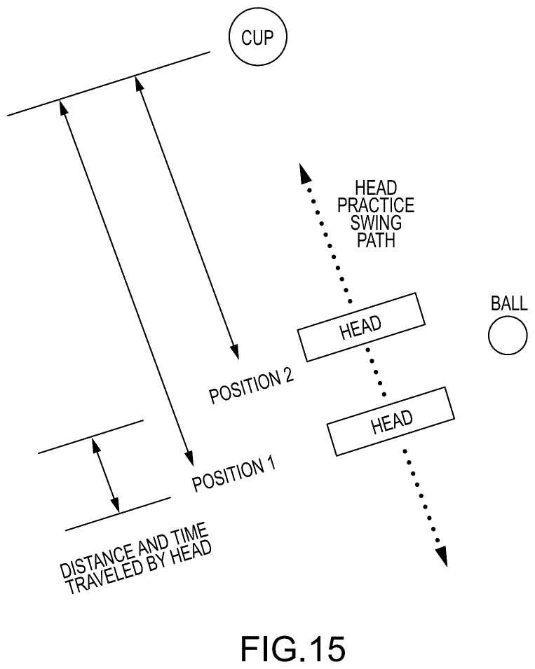

In this regard, the system may set the mass of the virtual ball to a real-world value, set the duration of the impact time between the putter face and the ball based on real-world values, and track the speed of the virtual putter face as it swings across the virtual mesh. For example, the LiDAR system (or camera images and appropriate logic) can be used to determine the position of the putter face at two times during a stroke (see FIG. 15). An average velocity can then be obtained by dividing the change in position by the difference in the corresponding times. Such measurements may be implemented multiple times in connection with the stroke to obtain a velocity profile of the stroke and/or to determine acceleration information. The putting force may also be correlated to other factors such as stroke length or stroke time. In this manner, the system can provide force estimates prior to and during putt execution.

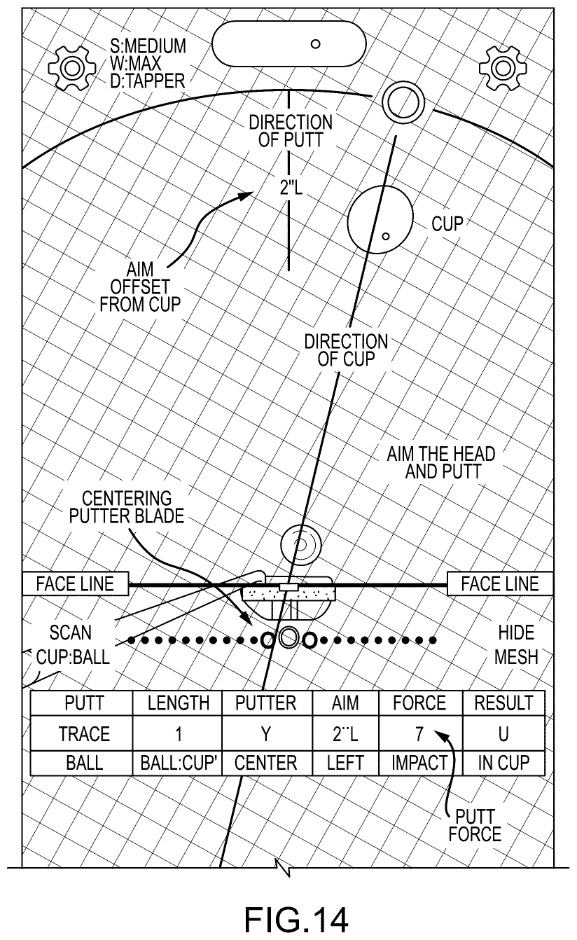

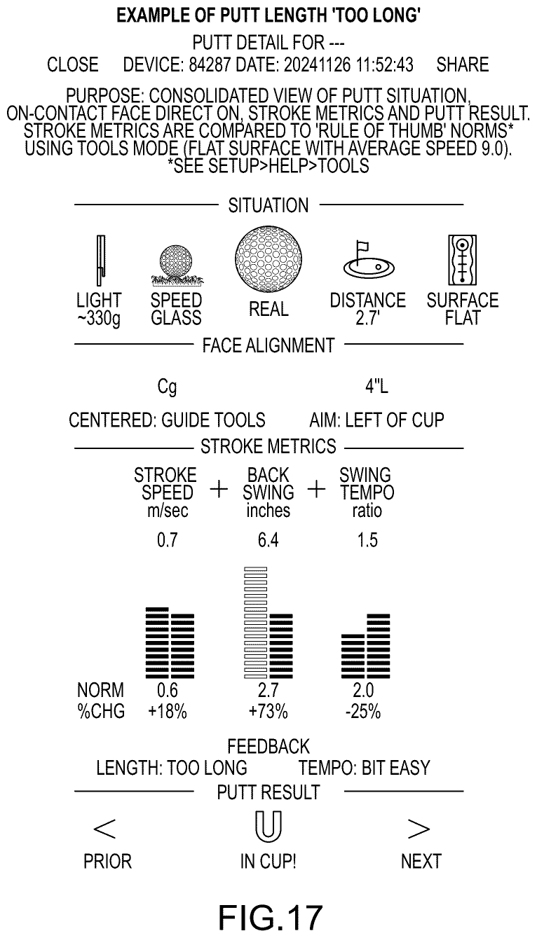

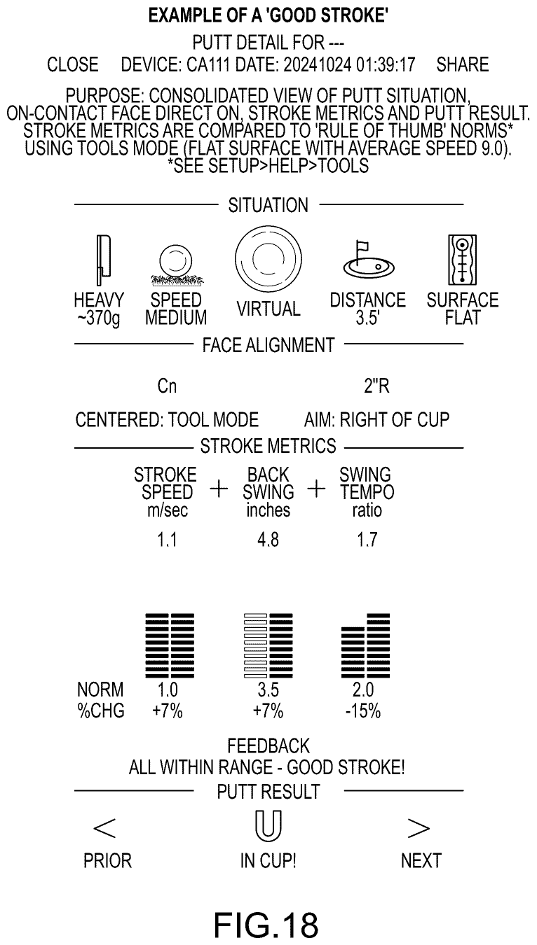

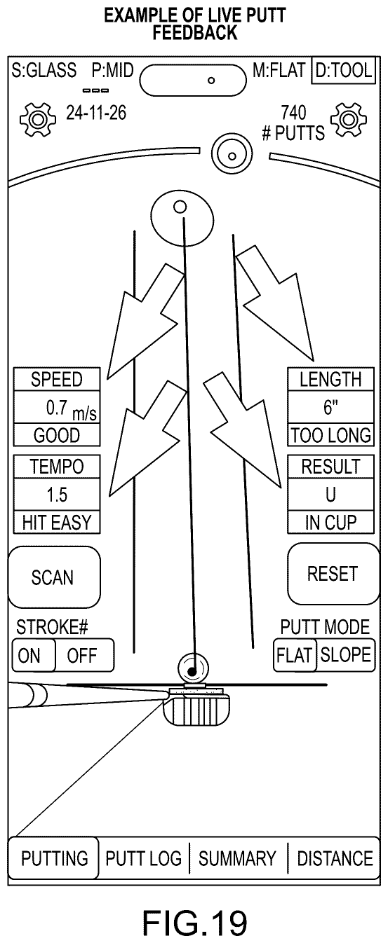

This information may be used to determine, for example, whether a putt ends short of the target, extends beyond the target, is the correct speed to reach the target, and how much the putt may break due to green contours or other factors. A corresponding process involves:
1. Calculating the putt distance, as described above, from the virtual ball center to the virtual cup center. This distance may be calculated in three dimensions.
2. Use the force equations and logic to determine a putt stroke force and resulting putt path and distance.
3. Present a visual indicator to show the putt result. For example, a projected putt path may be displayed on the device display so that the user can readily determine whether the path intersects the cup. In addition, textual indications may be provided to indicate that the putt missed to the left, missed to the right, came up short, or the like (see FIGS. 14 and 17-19).
4. This information can also be used to predict a putt outcome if the real ball is continuing on its projected pathway and not in view of the camera, thus precluding any AI/ML processing to occur.

### Stroke Mechanics

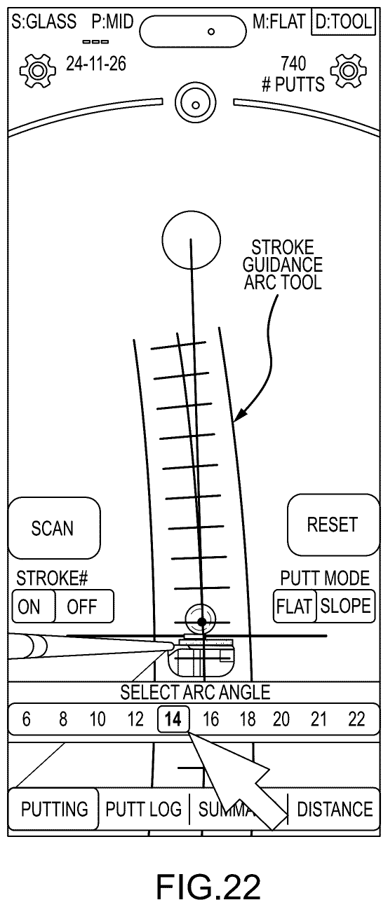

It is also useful for the system to track and analyze stroke mechanics. Stroke mechanics relate to the length of the stroke, the speed of the stroke, the timing of the stroke, and other mechanics of the stroke. There are certain preferred stroke characteristics that promote consistency and improved results. In addition, certain parameters of these stroke mechanics can be used to improve estimations of the putt path and distance. Certain stroke mechanics parameters can be monitored by the system as follows:
1. The system may first identify stroke initiation. This may be identified based on identifying initiation of rearward movement of the putter face away from the ball.
2. The system can then identify transition from the backswing to the downswing portion of the stroke. If the movement of the putter face is continuously monitored, this point will be indicated by a change in direction from rearward to forward in relation to the fixed position of the ball. By knowing the initial position of the putter face and the position of the transition from the backswing to the downswing, the total length of the backswing and time of the backswing can be determined.
3. The time and position of the initial contact between the putting face and the ball may be determined. Total time of the downswing from initiation of the downswing to impact can then be determined.
4. Optionally, post-impact parameters may be measured including, for example, duration of impact, change in putter face speed, the initial velocity of the ball, length of follow-through, and the like. Such parameters may be used in motion equations or AI/ML logic to improve putting path and distance projections.
5. The timing of the various swing components may be recorded and optionally displayed both in stroke mechanics reporting and/or other metric dashboards. This may include the time of the backswing, the time of the downswing, the time of the follow-through, the total swing time, the stroke tempo and any other timing related parameters.
6. Visual indicators may be provided in relation to the swing analysis. For example, using augmented reality logic, the shape and length of the stroke pathway may be superimposed onto the mesh and viewed as arcs displayed on the screen. Also, the overall angle of the displayed arc pathway can be set by the user to suit the stature and putt position of the golfer—typically an overall arc angle from six degrees to 24 degrees could be selected (see, FIG. 22). The arc is superimposed over the putting surface (via the AR screen) and that it can be adjusted if the players stance or stature changes, or if two players are using the same device, it can be changed to suit their stroke. Optionally, different portions of the pathway may be provided in different colors or otherwise identified. The actual pathway may be shown in comparison to an ideal swing so that the user can identify differences relative to the ideal. In addition, textual information may be provided indicating any observed characteristics of the actual pathway such as deviation from a desired swing plane, tempo information (e.g., ratio of the time of the backswing to the downswing), overall stroke time, or other information.

With regard to tempo and timing information, tempo has been found to help players become consistent putters. A typical tempo goal is a tempo of two, meaning that the backswing takes twice as long as the downswing. However, it should be understood that one can have a desired tempo and still not deliver the appropriate force in order to move the golf ball the desired distance. Other factors, such as stroke length, are important. The distance of the backswing is closely tied to the tempo. Golf professionals often teach that a player should keep the tempo at 2 and should adjust the length of the backswing based on the distance to the cup, i.e., a 4-inch backswing will provide a shorter putt distance than a 7-inch backswing length if the tempo and total stroke time are the same. A further factor is the acceleration of the putter face. A player could have an appropriate backswing length and tempo, but the overall stroke speed could be too slow for the desired distance. The acceleration of the putter face for the downswing is important to determine the amount of kinetic energy the putter head contains and how much force is transferred to the golf ball by the putter face on contact. Using these metrics, the force required to move the ball the required distance can be calculated in swing dynamics can be analyzed.

The system can compare measured metrics to reference values to provide feedback concerning stroke mechanics. Various references can be used in this regard including known standards, “ideal” stroke norms, or any metrics or combinations thereof learned based on analysis of an accrued knowledge base of putting information. Some examples of current norms, which vary over time as “best in class” research continues, include norms concerning tempo, backswing length, and putt head speed.

Tempo-as discussed above, the current norm is 2 (defined as the ratio of downward swing time divided by backward swing time).

Backswing length: the norm currently in use is 1″ of backswing for every 1 foot of putt distance—so a 4 foot putt would have a norm of 4″.

Putt head speed: use the norms for tempo and stroke length and apply other available parameters like putt distance, friction of putt surface, putter head weight, ball weight etc. to generate the “ideal” speed.

While various other norms can be used, the system compares the actual measured parameters of a user's swing, or derivatives thereof, to the norms and provides display feedback. For example, the display may indicate that the tempo was too quick or too slow, that the backswing length was too long or too short, etc. In this manner, the user not only gets guidance concerning how to execute a putt or the outcome of a putt or putts, but also guidance concerning putting stroke mechanics in relation to a standard or optimal stroke. It will be appreciated that good mechanics are expected to ultimately translate to better and more consistent putting performance.

While the system has been described in relation to certain putting scenarios, it will be appreciated that the system is applicable in other contexts. For example, the system is not limited to monitoring putts but may be applied to other clubs and strokes. For example, the system may be used, with appropriate modifications, in connection with chipping or other clubs/strokes. In such cases, factors such as the angle of the club face, the path of the swing at contact, and the spin of the ball may be considered. Similarly, topological putt dynamics may be determined and displayed. For example, baseline parameters such as the putting force, the initial ball velocity and direction, and the like may be calculated. In addition, the LiDAR system may be used to calculate the topography of the putting surface relative to the projected putt path. Gravity effects may then be integrated over the path of the putt. Those effects may be determined as a function, for example, of putting force, initial velocity, or the like. The resulting putting path as affected by the topography of the putting surface can then be displayed to the user.

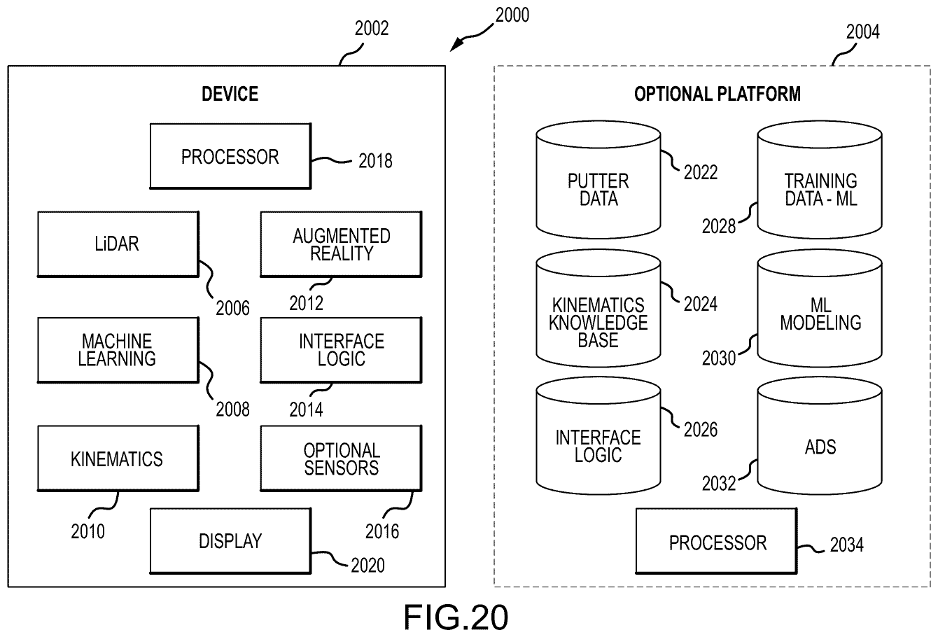

FIG. 20 is a schematic diagram of a putting aid system 2000 in accordance with the present invention. The illustrated system 2000 includes a putting aid device 2002 and an optional putting aid platform 2004. As noted above, it is useful for a putting aid device to be operative without requiring a continuous connection to any remote network platform. In that manner, the putting aid system can be used on golf courses or other potentially remote locations where an Internet connection may not be available. However, in certain cases, it may be useful to connect to the platform 2004 either continuously during use or periodically to exchange information with the platform 2004. For example, the device 2002 may optionally establish a connection with the platform 2004 during use to access data, AI/ML models, and the like. Alternatively, the device 2002 may operate independently during use but may then be periodically connected to the platform 2004. For example, it may be useful to periodically or occasionally connect the device 2002 to the platform 2004 to upload putting data to improve models at the platform 2004, to download updated models and software updates from the platform 2004, and to exchange other information. In this manner, the platform 2004 may develop a large knowledge base of information about putting strokes, putting surfaces, conditions on particular golf courses, and the like.

The illustrated device 2002 may be embodied in a mobile device such as a phone or other compact system that can be connected to a putter as described above. The illustrated system includes optical equipment such as a LiDAR system 2000. The system 2000 can be used to scan a putting surface, establish a virtual mesh, monitor putter and ball movement, and the like. The device 2002 may further include machine learning logic 2008 such as AI/ML logic. This logic 2008 may be used for various purposes in the device for the detection, identification and placement of real-world objects. LiDAR 2006 may be used for various purposes such as building, updating, and maintaining the virtual mesh and, in conjunction with an integrated augmented 2012 logic system, establish virtual objects such as a virtual ball and cup, estimating various quantities such as putt stroke force based on monitored parameters, projecting swing paths and putt paths, and others. The kinematics module 2010 includes force equations, stored kinematic data for actual or ideal swings, and other information related to movement of the putter and ball or other factors. The kinematics module 2010 may be used as an alternative to or in combination with the machine learning logic 2008 and the LiDAR 2006 system.

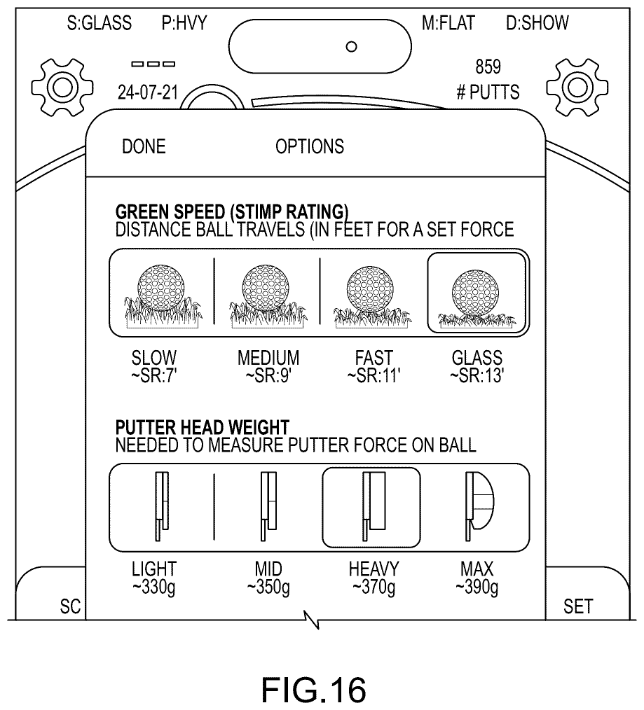

The augmented reality logic 2012 is used to generate various augmented reality display elements. As described above, the system 2000 may display a variety of augmented reality information such as a virtual ball, a virtual cup, a projected travel path for a putt, and other information. The logic 2012 can generate such elements and display them at the appropriate positions and in the appropriate scale on the device display 2020. Interface logic 2014 is operative to generate various user interfaces and receive information via user interfaces. The user interfaces may include screens by which the user can enter information about a putter, a desired application, green speed, projected putt information, putt result information, and putting statistics (see FIG. 16). The system may also utilize additional optional sensors 2016. The optional sensors may be of various types such as tilt sensors, accelerometers, microphones, cameras, and others. These sensors may be sensors that are available on the device 2002 or dedicated sensors provided to support and enhance the system 2000. Other tools of the user device, or specially provided tools, may be used by the system. For example, in connection with virtual putts, a speaker may be used to generate sound effects for the ball strike and, when appropriate, the sound of the ball falling into the cup. In addition, the use of the device's tactile feedback generator can be enabled when a collision of the putter face object and the ball object occurs, thus mimicking a ball strike. The processor 2018 is operative to run the various logical elements of the device 2002.

The illustrated platform 2004 includes a database of putter data 2022. For example, the putter data 2022 may include information regarding the putter length, putter weight, face weight, or other information concerning popular putters. In this manner, a user of the system can identify the putter being used and the system can access information to assist in operating the putting aid. The platform 2004 may further include a kinematics knowledge base 2024. The knowledge base 2024 may include a variety of information useful for projecting putting paths and analyzing results such as stroke dynamics, green speed data, putting surface contour data, kinematics and force equations, and any other information useful in operating the putting aid system.

Interface logic 2026 can generate interfaces for exchanging information between the device 2002 and platform 2004 and may include interface graphics information, information concerning messaging formats, fields, attributes and the like, and logic for populating messages and extracting information from messages, among other things. The platform 2004 may also include or have access to machine learning training data 2028. Beyond the traditional use of training imagery to detect a variety of golf cups, golf balls, indoor cup markers, the training data may include, for example, a library of recorded putts together with data such as the associated green speed, the putter used, the location of the putt, and any other information useful for developing AI/ML models. The machine learning modeling logic 2030 continually develops machine learning models based on analysis of training data and additional data obtained during use of the system 2000. Over time, it is expected that the models will become increasingly accurate in projecting putt paths, putt lengths, putt breaks, and other information based on monitored parameters. The platform 2004 may further include an ads database 2032 that may be used in connection with the system. It will be appreciated then many advertisers such as golf equipment and clothing manufacturers may desire to have access to users of the system 2000. The costs of developing and maintaining the system 2000 may be defrayed by generating revenues from such optional advertisements. The processor 2034 is operative to run the various logical elements of the platform 2004.
a. Although a single user device is shown, it will be appreciated that many user devices may be employed and may interface with the platform. As described herein, the user devices communicate with the platform to implement a variety of functions. Although the platform is illustrated as a single element, it will be appreciated that the platform may be executed on one or more machines (e.g., computers or servers) at a single site or geographically distributed. Each such site may execute the full functionality of the illustrated platform, or the functionality may be distributed across sites. Moreover, the functionality may be distributed in various ways between the platform, the user devices, and any other platforms, e.g., some preprocessing of information may be executed at the user devices or other platforms, for example, to facilitate rapid response or reduce use of processing resources of the platform or communication bandwidth requirements. The platform may be hosted by a system provider or may be implemented separately (e.g., cloud-based) and connected to the system provider via an interface such as API.

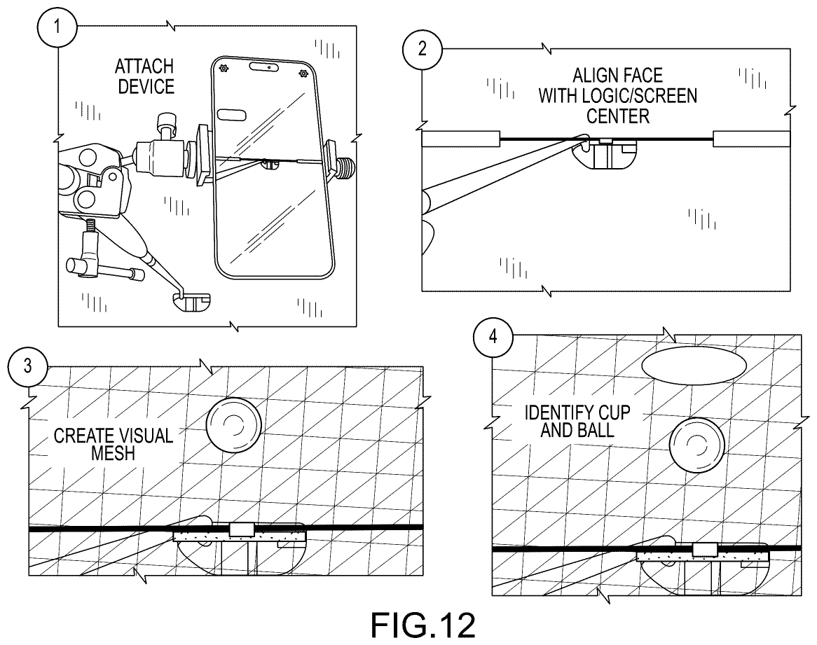

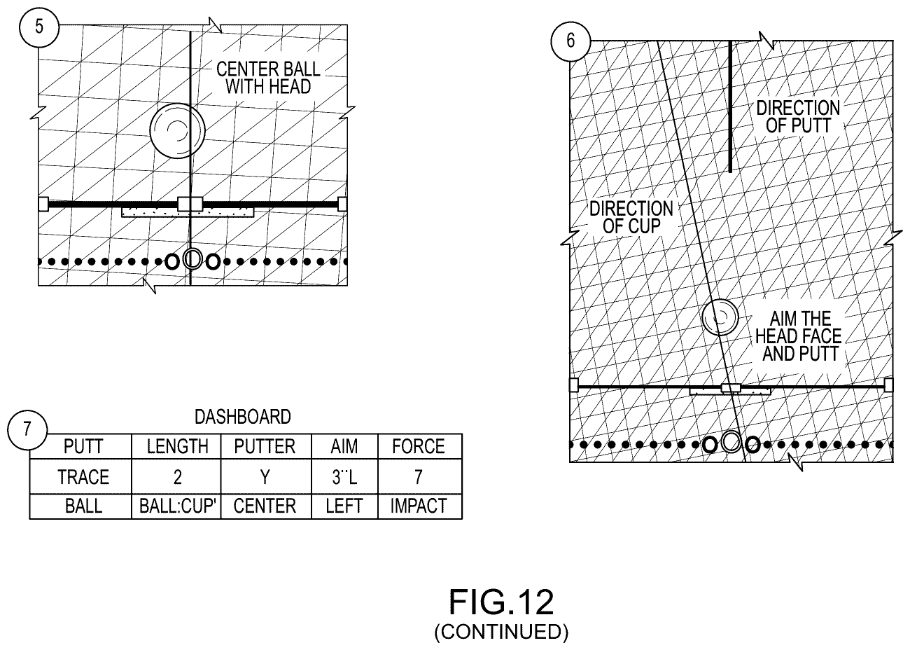

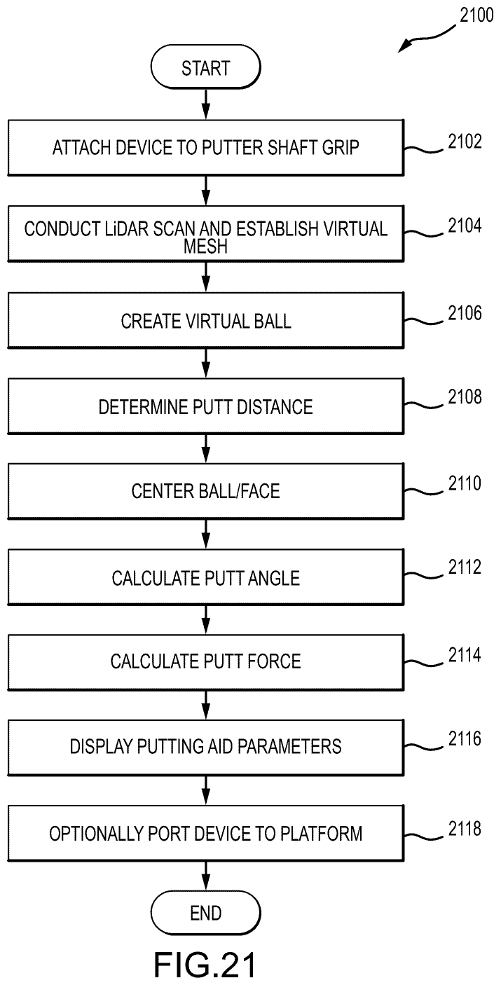

FIG. 21 illustrates a putting aid process 2100 in accordance with the present invention (see also FIG. 12). The illustrated process 2100 is initiated by attaching (2102) the device to a putter shaft. As described above, the device may be embodied in a data enabled telephone and may be attached to the shaft via an adjustable mount. The device is preferably attached to the putter shaft at or near the top end of the shaft opposite the putter face. Once the device is attached to the shaft and the mount is adjusted so that the device is properly aligned, a LiDAR scan of the putting surface may be conducted (2104) and a virtual mesh may be established. The system may then be operated to create (2106) a virtual ball and other virtual objects such as a virtual cup and virtual putter face. In cases where the system is being used with a real ball, the virtual objects may be positioned to match the locations of real objects such as a real ball and real cup.

The system can then be operated to determine (2108) the putt distance. For example, the putt distance may be determined as the three-dimensional distance between the center of the virtual ball and the center of the virtual cup. The putt angle or target direction may also be calculated (2112). The putt angle may be determined as a bearing of a line connecting the center of the virtual ball to the center of the virtual cup. As discussed above, an aiming direction may also be determined based on the orientation of the putter face and an offset angle may be determined by comparing the aiming direction to the target direction. In addition, a putt stroke force may be calculated (2114). Using equations of motion and/or ML/AI logic, the required putt stroke force may be determined based on factors including the length of the putt, the speed of the green, the contours of the putting surface, and other factors. The device can then display (2116) putting aid information. Such information may be displayed, for example, in advance of a putt to guide the user, after a putt to show the results of the putt, or after a series of putts to display cumulative putting information. Optionally, the device may be ported (2118) to a network platform, either during use or between uses. The device may be ported to the platform to exchange putt log data and/or information to improve performance of the device and performance of the overall system.

The system may be used in other contexts than as a training device or on-course putting aid. For example, the system may be used to support a game show where amateur golfers, assisted by the putting aid device, compete with professional golfers. The amateur and professional golfers can compete in various types of putting contests for prizes. For example, the game show could be staged on a set with predetermined hole layouts. These layouts could be based on well-known holes from famous golf courses or simply holes that test various aspects of putting skill. Examples include a long straight putt, a sloping putt, mixed topography putts, and long mixed topography putts. For each game show episode, the hole designs may remain static or vary based on contestant's skills, the invited professional, and/or the event status, for example, a season finale. These games show holes may replicate or be close approximations of typical golf greens found on a golf course though, perhaps, limited in size and made of synthetic materials. Alternatively, the game may actually occur at a known golf course. Selected holes are chosen to putt. The chosen golf course may vary for each episode.

The participants may include a game show host, selected contestants, and an invited professional. The format may be match-play (professional versus contestant) or a foursome (3 contestants against the professional) among other possibilities. The professional may be paid an appearance fee, and any professional winnings may go to a charity of the professional's choice. During the contest, the professional would not have the use of any putting aid equipment while the contestants would have their choice of putter and putting aid equipment. In this way, the competitive element would be maintained-essentially pitting professional skills against technology assisted talent.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed:

1. A putting aid system for golfers, comprising:
a user device for monitoring one of objects and movement within a monitored area, said user device including a monitoring unit and a processor; and
a mount for mounting said monitoring unit on a putter;
wherein said processor is operative for receiving monitoring information from said monitoring unit and providing putting aid information based on said monitoring information to aid a user in executing a putt using said putter.

2. The system of claim 1, wherein said monitoring unit comprises an optical unit for monitoring one of objects and movement within a field of view of said optical unit.

3. The system of claim 2, wherein said optical unit comprises a lidar system.

4. The system of claim 1, wherein said user device is a phone.

5. The system of claim 1, wherein said processor is operative for establishing a virtual mesh extending across a measurement area, said virtual mesh having a fixed spatial relationship to an environment of a golf ball addressed by a putter head of said putter.

6. The system of claim 5, wherein said processor is further operative for using said virtual mesh for measuring movement of said putter head in relation to said golf ball.

7. The system of claim 5, wherein said processor is further operative for determining an orientation of said putter head.

8. The system of claim 7, wherein said processor is further operative for determining a geometry relating said orientation to a path between said ball and a hole.

9. (canceled)

10. (canceled)

11. The system of claim 5, wherein said processor is further operative for measuring a parameter related to a striking force of said putter head relative to said ball.

12. The system of claim 11, wherein said processor is further operative for comparing said striking force to a distance between said ball and a hole.

13. The system of claim 1, wherein said user device comprises a display and said mount holds said user device so that said display is visible to a user of said putter when said putter is positioned to address said golf ball.

14. The system of claim 13, wherein said display is operative to display information to aid said user in executing said putt.

15. (canceled)

16. (canceled)

17. The system of claim 15, wherein said processor is operative to superimpose an arc corresponding to a putting stroke on said display.

18. The system of claim 1, wherein said processor is operative for comparing one or more measured stroke parameters to reference stroke parameters.

19. The system of claim 1, wherein said processor is operative for providing said putting aid information based on processing resources internal to said user device free from the need to establish a network connection to an external network platform.

20. The system of claim 1, wherein said mount mounts said user device at a mounting location near a proximal end of said putter, wherein said putter includes a putter head for striking a golf ball at a distal end of said putter and a grip for gripping said putter covering a grip section of said putter adjacent to said proximal end of said putter;
said mounting location being no more than 3 inches from said proximal end.

21. The system of claim 20, wherein said mount is adapted for mounting on said proximal end of said putter.

22-40. (canceled)

41. A putting aid method for golfers, comprising:
providing a user device for monitoring one of objects and movement within a monitored area, said user device including a monitoring unit and a processor, and a mount for mounting said monitoring unit on a putter; and
operating said processor for receiving monitoring information from said monitoring unit and providing putting aid information based on said monitoring information to aid a user in executing a putt using said putter.

42. The method of claim 41, wherein said monitoring unit comprises an optical unit for monitoring one of objects and movement within a field of view of said optical unit.

43. (canceled)

44. The method of claim 41, wherein said user device is a phone.

45. The method of claim 41, further comprising operating said processor for establishing a virtual mesh extending across a measurement area, said virtual mesh having a fixed spatial relationship to an environment of a golf ball addressed by a putter head of said putter.

46. The method of claim 45, further comprising operating said processor for using said virtual mesh for measuring movement of said putter head in relation to said golf ball.

47-53. (canceled)

54. The method of claim 41, wherein said display is operative to display information to aid said user in executing said putt.

55-59. (canceled)

60. The method of claim 41, wherein said mount is operative to mount said user device at a mounting location near a proximal end of said putter, wherein said putter includes a putter head for striking a golf ball at a distal end of said putter and a grip for gripping said putter covering a grip section of said putter adjacent to said proximal end of said putter,
said mounting location being no more than 3 inches from said proximal end.

61-80. (canceled)
